(19) United States
(12) Patent Application Publication
(10) Pub. No.: US 2010/0051442 A1
(43) Pub. Date: Mar. 4, 2010

(54) Organic material possessing novel properties, method, and appartus for making the same

(76) Inventor: Vladimir Tarnovsky, Fair Lawn, NJ (US)

Correspondence Address: Aleksandr Smushkovich, POB 140505, Brooklyn, NY, 11214, US

(21) Appl. No.: 12/583,273

(22) Filed: Aug. 18, 2009

Related U.S. Application Data
(60) Provisional application No. 61/190,882, filed on Sep. 3, 2008.

(51) Int. Cl. B01J 19/08

(52) U.S. Cl. 204/156; 260/1

(57) ABSTRACT

An organic material is produced through a method comprising the steps of —providing a chemical reactor, in embodiments, including a vessel associated with a plasma housing capable of initiating a plasma discharge that produces predetermined byproducts, —dissolving a solid dye in water, obtaining a dye solution that is placed in the vessel, —elevating a temperature and adjusting a pressure inside the vessel up to predetermined temperature and pressure respectively, —injecting the byproducts into the dye solution thereby commencing a chemical reaction, the reaction proceeds during a predetermined time, and further results in obtaining the organic material, and —extracting the organic material from the dye solution. Other chemical reactor embodiments comprise means for heating the solution for modulating properties of the organic material. Preferable method parameters are disclosed herein. Several apparatus embodiments are described, including those with an additional reactor joined with the chemical reactor further modifying the obtained organic material.

### CROSS-REFERENCE TO RELATED APPLICATIONS

The present nonprovisional patent application partially claims the benefit of a U.S. provisional patent application No. 61/190,882 filed on Sep. 3, 2008, the disclosure of which is incorporated herein in its entirety by reference. The present patent application also contains new parts, which were not previously disclosed in the above-indicated provisional application.

### FIELD OF THE INVENTION

The present invention relates to the field of organic chemical technologies, particularly to the plasma-assisted organic chemistry and/or to the thermal-assisted organic chemistry.

### BACKGROUND OF THE INVENTION

As well known, organic based materials are widely produced and consumed in a variety of forms, from plastics to semiconducting polymers, artificial enzymes, and biocompatible implants. This invention opens up new fundamental and technological avenues to manufacture new organic based materials with a wide range of novel and exotic properties.

### BRIEF SUMMARY OF THE INVENTION

The subject matter disclosed herein relates to the production of a novel class of organic matter. The invented material combines thermally and chemically inert hydrophobic outer layer and a hydrophilic inner core, organizing organic elements C, H, N, S, Cl, O, X (X=Metal) in two distinct by molecular weight layers which are integrated into one chemically functional structure.

The inventive organic material possesses a number of highly functional properties, such as inertness in all acids and bases, ability to be affected by electromagnetic fields, initiation of chemical reactions on its surface, and stability in high temperature environments. As a result, the material possesses a wide range of unusual properties, among them a high degree of inertness in all known solvents, active interaction with bio-molecular substances, and ability to be affected by external electric fields in solutions.

In a variety of embodiments, the inventive material can be utilized in a wide range of applications, from quantum computers, electro-motors at the micro- or nano-scale, micro-scale gyroscopes, drug delivery systems, dielectric shielding, new sources of energy, new pharmaceutical products, new electronic devices, new propulsion systems, and so on.

The inventive material exhibits at least the following observable properties: organic nature; amorphous; fractal-like geometry (the material can be produced in a powder-like form from a sub-micron to 0.1 mm long at least in two types of shapes: a rectangular slab or a needle-like shape); chemical inertness; supposedly strong catalytic properties (it does not dissolve in water that makes it a very convenient and useful catalyst for bio-chemical applications); dielectric in the DC mode, but might be electrically conductive in the AC mode; permanent electromagnetic dipole; it slowly sublimates at a temperature about 1000 C; and dual properties as an electron donor or electron accepter, depending on the chemical boundary conditions.

Particularly, in the aspect of chemical inertness, the following peculiarities have been observed: the material exhibits no reactivity from strong acids to strong bases; it sinks in and is non-soluble by acetone; it floats in and is non-soluble by methylene chloride; it sinks in and is non-soluble by ethanol; it floats in and is non-soluble by acetic acid; it sinks in and is non-soluble by 2% hydrochloric acid; it floats in and is non-soluble by concentrated hydrochloric acid; it sinks in and is non-soluble by diethyl ether; it floats in and is non-soluble by 2% sodium hydroxide; it sinks in and is non-soluble by concentrated sodium hydroxide; and it sinks in and is non-soluble by benzene; it sinks in and is non-soluble by ethyl acetate.

The inventive organic material is preferably produced through a method comprising the steps of —providing a chemical reactor, in embodiments, including a vessel associated with a plasma housing capable of initiating a plasma discharge that produces predetermined byproducts; —dissolving a solid dye in water, obtaining a predetermined dye solution that is placed in the vessel; —elevating a temperature and adjusting a pressure inside the vessel up to predetermined temperature and pressure respectively; —injecting the byproducts into the dye solution thereby commencing a chemical reaction, the reaction proceeds during a predetermined time, and further results in obtaining the organic material; and —extracting the organic material from the dye solution. Other chemical reactor embodiments comprise means for heating the solution for modulating properties of the organic material. Preferable method parameters are also disclosed herein. Several apparatus embodiments are described, including those with an additional reactor joined with the chemical reactor further modifying the obtained organic material.

### BRIEF DESCRIPTION OF THE DRAWINGS

FIG. 1 illustrates an image of rectangular fractal-like structure of the organic material according to an embodiment of the present invention.

FIG. 2 illustrates an image of needle-like fractal-like structure of the organic material according to an embodiment of the present invention.

FIG. 3 illustrates a block-diagram of an apparatus assembly for production of the organic material according to an embodiment of the present invention.

FIG. 4 illustrates a block-diagram of an apparatus assembly for production of the organic material according to another embodiment of the present invention.

FIG. 5 illustrates a block-diagram of an apparatus assembly for production of the organic material according to another embodiment of the present invention.

FIGS. 6a and 6b illustrate block-diagrams of apparatus assemblies for production of the organic material according to other embodiments of the present invention.

Identical reference numerals on the drawings generally refer to the same elements, unless otherwise is stated in the description. A newly introduced numeral in the description is enclosed into parentheses.

### PREFERRED EMBODIMENTS OF THE PRESENT INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

### Preferred Apparatus Embodiments for Plasma-Assisted Producing the Inventive Material

The inventive organic material can be produced by: (A) an apparatus including a plasma device with no external heating means; or (B) an apparatus including external heating means with no plasma device; or (C) an apparatus including external heating means and a plasma device, which Options A, B, and C represent the plasma device and/or the heating means as modulators of a chemical reaction necessary for production of the inventive organic material.

An apparatus for contacting a liquid with a plasma afterglow (see Option A above) is disclosed in a U.S. patent application Ser. No. 12/201,229 filed by the instant inventor on Aug. 29, 2008, the disclosure of which is incorporated by reference in its entirety.

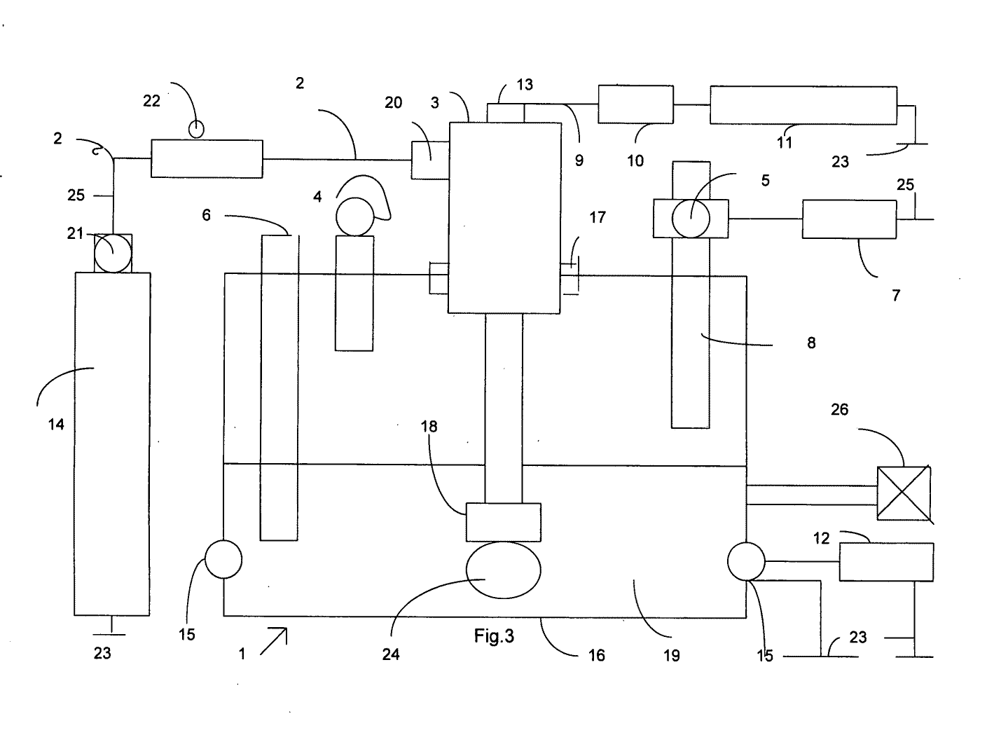

In a preferred embodiment (according to Option C), the present invention relates to a batch method of producing a new composite organic-based solid material from an organic dye by combination of the external thermal heating (e.g. electro-heating, and/or microwave heating, though other known types of external heating can be suitably utilized as well), adjusted pressure, and plasma-induced non-equilibrium rearrangements of the dye in a main chemical reactor (1), whose preferred embodiment is depicted on FIG. 3. The chemical reactor 1 is essentially fed from a gas cylinder (14). The reactor 1 comprises a plasma housing (3), having an inlet communicating with the gas cylinder 14 via a gas supply line (2) and a flow meter (20). The plasma housing 3 is furnished with a high voltage connector (13) and a sealed screw connector (17).

The reactor 1 comprises a reaction vessel (16) wherein a dye solution (19) is placed. The dye solution can be chosen in a predetermined concentration, including the case where the dye is used in the dry form, i.e. without any solution in water. The vessel 16 is made of predetermined material. The vessel material, specifically if it is metallic in nature, can affect the final composition of the inventive organic compound. In one case, an iron vessel was used, and the resultant organic product retained iron in a magnetic state. In another case, a silver vessel was used, and the resulted organic product incorporated silver into its outer surface.

The vessel 16 is covered by a removable lid. The vessel 16 is assembled with the plasma housing 3 through the sealed connector 17. The interior of vessel 16 communicates with the plasma housing 3 via an exit (outer) cup (18). A plasma reaction volume is operatively formed in a region approximate to the cup 18, which reaction produces predetermined byproducts. The vessel 16 also comprises a pressure gauge (4), a temperature control device (6), and a vent valve assembly (8), including a pressure vent valve (5) preferably communicating with a condenser (7), resupplying gas into the gas cylinder 14.

A high-voltage power source (11) supplies a predetermined DC voltage via a load resistor box (10) used for current control, and via a high-voltage power cable or cord (9), electrically connected with the box 10 to the plasma housing 3. The electric current substantially causes producing plasma in the plasma housing 3. The power source 11 should preferably provide 10 Kv and 150 mA of electrical direct current.

The reactor 1 comprises a number of thermal heating devices represented, for example, by electro-heating coils (15) acting as chemical reaction modulators. The coils 15 are connected with an electric power supply source (12) connected to a grounding (23). In particular embodiments, the heating devices, at least in part, can be represented by microwave heating devices that could be arranged, for example, around the vessel 16, as shown on FIG. 3. The coils 15 and the power source 12 produce an additional degree of control of the pressure and temperature of the interior of the vessel 16.

The aforementioned U.S. patent application Ser. No. 12/201,229 describes a direct plasma injection mechanism taking place in a mixture of plasma byproducts and liquid droplets enclosed in a gas bubble produced by the gas flow within a plasma housing. As discussed above, the coils 15 and/or the direct plasma injection mechanism, or any combination thereof can essentially initiate the chemical reaction in the reactor 1.

Apparatus Embodiments with an Additional Reactor

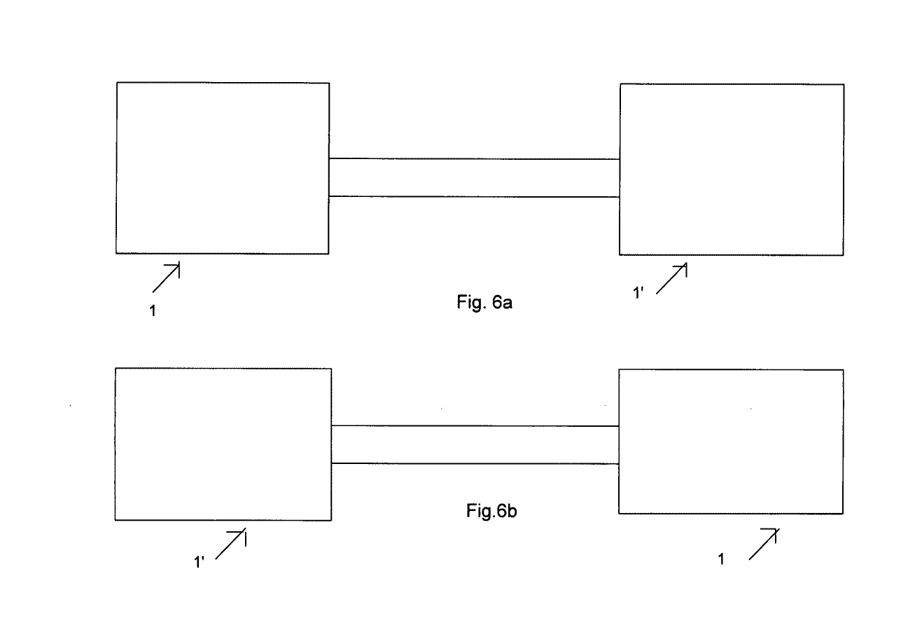

In some embodiments, an additional reactor (1′) is used, e.g. for final separation of the material, produced in the reactor 1, from the water solution. The two reactors are schematically illustrated in another embodiment of the material production apparatus sequential assembly shown on FIG. 6a. The reactor 1′ can be used for complete water removal by thermal heating means (e.g., similar to the aforesaid coils 15), providing an additional heating of the material produced in the reactor 1 and supplied to the reactor 1′.

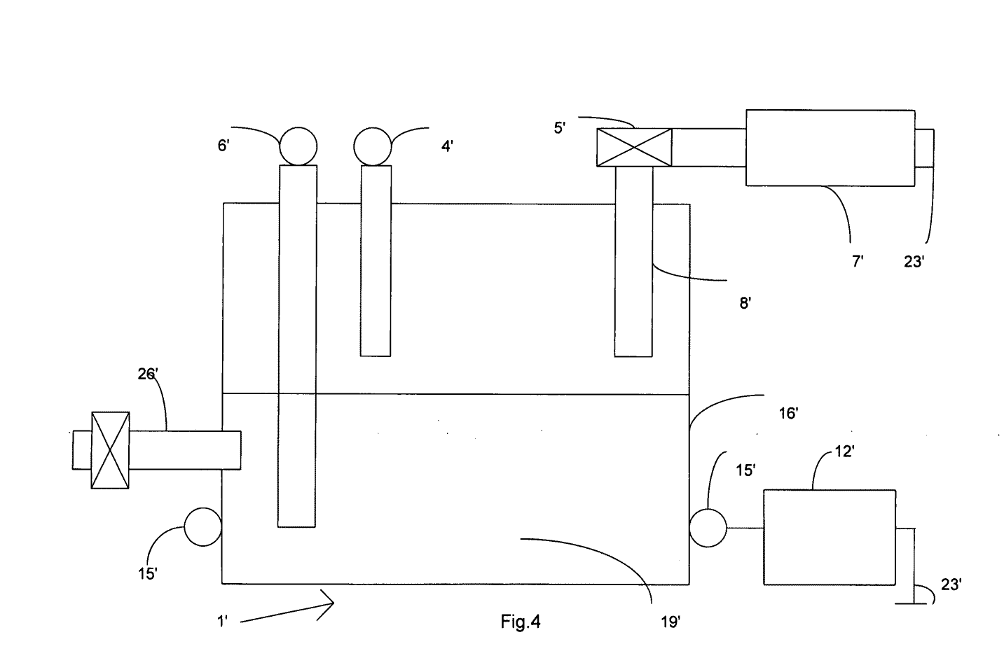

In such a case, depicted on FIG. 4, the reactor 1′ comprises a vessel (16′) made of predetermined material, wherein an intermediate dye solution (19′) is supplied via a junction connector (26′) from the reactor 1 (shown on FIG. 3) to the vessel 16′ of reactor 1′.

The vessel 16′ is covered by a removable lid. The vessel 16′ comprises a pressure gauge (4′), a temperature control device (6′), and a vent valve assembly (8′), including a pressure vent valve (5′) preferably communicating with a condenser (7), resupplying the condensed gas, for example, into the gas cylinder 14 (shown on FIG. 3). The pressure gauge 4′, temperature control device 6′, and vent valve assembly 8′ are preferably mounted on the removable lid.

The reactor 1′ comprises thermal heating means, for instance, a number of electric heating coils (15′), acting as chemical reaction modulators. The coils 15 are connected with an electric power supply source (12′) properly connected to a conventional grounding (23′). In particular embodiments, the heating means, at least in part, can be represented by microwave heating devices that could be arranged, for example, around the vessel 16′, similar to the coils 15′. The coils 15′ and the power source 12′ produce an additional degree of control of the pressure and temperature of the interior of the vessel 16′.

In an alternative embodiment schematically shown on FIG. 6b, the additional reactor can be represented by a reactor 1 including the plasma housing, whereas the first reactor can be represented by a reactor 1′ (without a plasma device, but including thermal heating means as the modulator of the chemical reaction, e.g. electric coils, microwave devices, etc.), and the reactors are joined by a junction connector (not illustrated, similar to the aforementioned connector 26′), and sequentially utilized for production of the inventive organic material.

This production can be accomplished in two ways: (i) a predetermined dye solution is placed into the reactor 1′ and is processed with the help of the thermal heating means obtaining an intermediate resultant product, a predetermined dye solution is placed in the reactor 1, the intermediate resultant product is extracted from the reactor 1′ in the dry form and is placed in the dye solution of reactor 1, wherein it's processed with the plasma discharge as described above for modifying the properties of the final product; (ii) a predetermined dye solution is placed into the reactor 1′ and is processed with the help of the thermal heating means obtaining an intermediate resultant product, the intermediate resultant product is extracted from the reactor 1′ in the dry form and is placed in the reactor 1, wherein the surface of the dry product is processed with the plasma discharge as described above for modifying the properties of the final product.

### Apparatus Embodiments for Thermal-Assisted Producing the Inventive Material

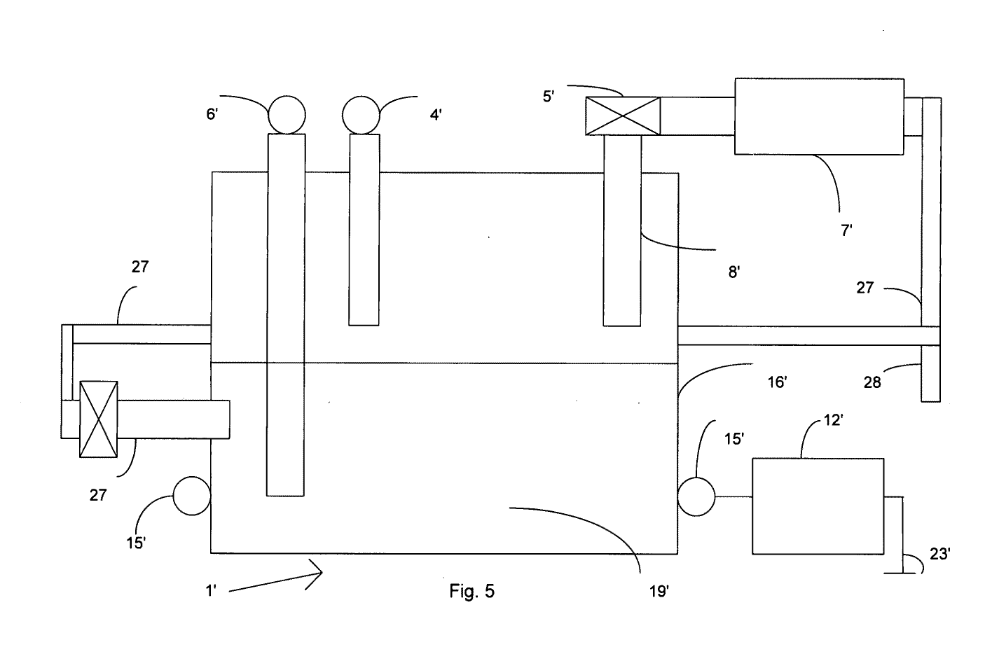

On the other hand, the reactor of the type 1′ (with no plasma device) can also be utilized as a single (self-contained) device for production of the inventive organic material (see Option B above). Accordingly, the embodiment shown on FIG. 5 differs from the one illustrated on FIG. 3 in that it does not contemplate any plasma housing. The apparatus in this embodiment is structured almost identically to the one used as an additional reactor, depicted on FIG. 4, except for the condenser 7′ connected with the vessel 16′ via a junction line (27) that is also connected with a dump line (28) to another device (not shown) for utilizing the condensed gas.

Exemplary Methods for Plasma-Assisted Producing the Inventive Material and their Operation

Voltage and current supplied to the plasma housing 3 initiate a plasma discharge through the feeding gas, so the byproducts of the discharge are directly injected into the chemical reaction vessel 16.

The gas outlet allows the gas and vapor to exit the reaction vessel 16 via the pressure valve 5 that can control the flow rate of the escaping gases and vapor.

Exemplarily, a solid dry dye is dissolved in water (preferably, distilled water) and the dye solution 19 is obtained. The dye solution is prepared in any desirable concentration and placed inside the chemical reaction vessel 16. In a special case, the dye is processed in the reactor in the dry form without introducing any water, as mentioned above.

The pressure inside the vessel 16 is adjusted, preferably to 1.5 atmospheres, and the temperature inside the vessel 16 is elevated up to 100-120.degree.C, using the heating coils 15 and the pressure valve 5.

A direct injection of the plasma reactive materials (byproducts) is then initiated into the dye solution 19 in the interior of vessel 16. The dye solution 19 is contacted with the plasma byproducts commencing the chemical reaction. The rate of reaction can be modulated by adjusting the electric current through the coils 15, the plasma conditions, or the flow rate. The reaction proceeds for a predetermined time, preferably several hours (preferably in the range from 1 to 8 hours) per 100 mL of solution. The timing of reaction in the reactor 1 is generally determined by any lack of color of the dye solution 19 and visible precipitation of the resultant solid material in the solution, which material is then extracted from the solution.

It is possible to enhance or further modify the property of the resultant solid material using the same modulators, describe above: the plasma injection, the external heating, and the obtained organic solid material itself mixed with a dye solution in the additional reactor in the next cycle.

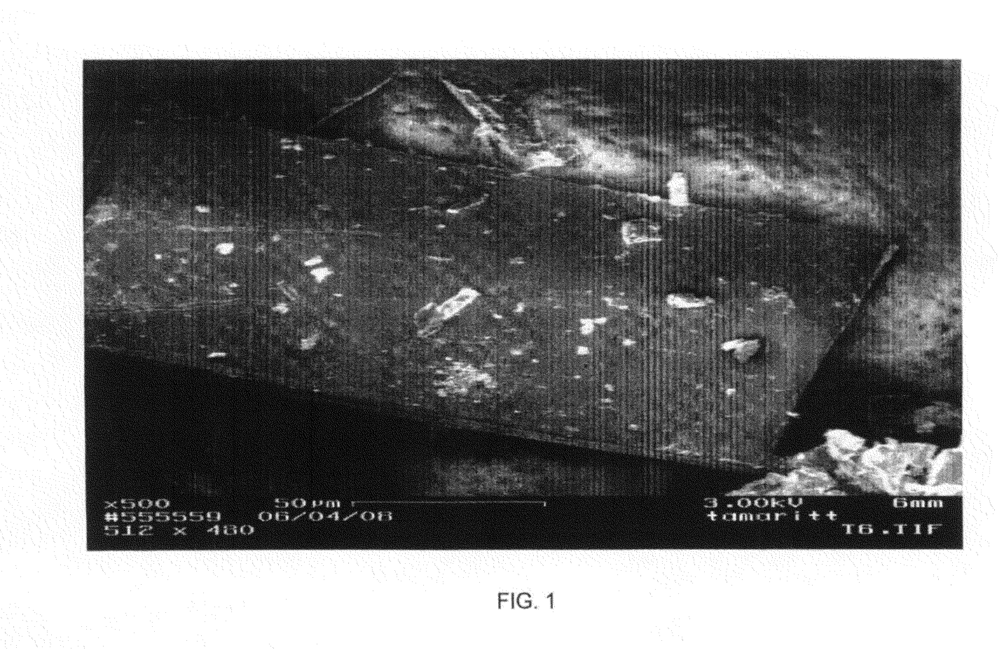

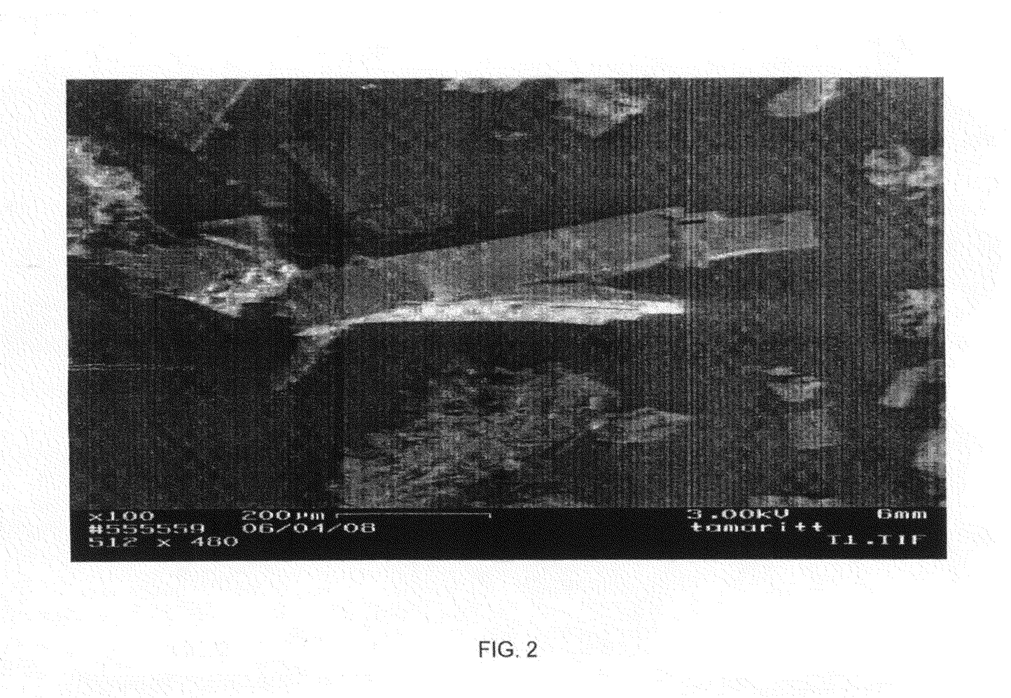

In an exemplary embodiment of the present invention, the inventive material is prepared from conjugated dyes in a water solution through the above-described multistage process including: contacting the dye solution with the plasma byproducts of a feed gas (e.g. air, oxygen, nitrogen, argon, and other noble gases) in order to initiate the reaction; keeping the resultant solution in a dark place for a few hours; heating the solution at about 100-120.degree.C (for example, in a microwave oven) for a few hours and removing water therefrom; and extracting the resultant solid organic material, whose structural forms are illustrated on FIGS. 1 and 2.

Exemplary conditions for the above disclosed process include: a plasma temperature maintained at about 800.degree.C, a temperature of the outer cup 18 of the plasma housing 3 maintained at about 20.degree.C, a gas (plasma) flow rate of about 15-16 L/min, a solution of about 1 mol of conjugated dye to about 100 mol of water, and a contact time between the plasma plume and the solution of about 2-4 hours.

The inventive process has been experimentally carried out in sealed reaction vessels, into which the solution has been introduced. It has been shown to produce repeatable results. There is no practical or theoretical reason to believe that the process could not be extended to other solutions than that of the example. This process can be scaled by increasing the number of plasma sources, the solution flow rates and the amount of liquid solution treated. Known process limitations include the flow rate of the solution, the temperature of the outer cup, and the durability of the plasma source over the period, during which the solution is contacted with the plasma.

I claim:

1. An organic material produced through a method comprising the steps of:
a) providing a chemical reactor, including a vessel made of predetermined material and associated with a first chemical reaction modulator in the form of a plasma housing capable of initiating a plasma discharge, said discharge is capable of producing predetermined byproducts;
b) dissolving a solid dye in water obtaining a predetermined dye solution that is placed in said vessel;
c) elevating a temperature and adjusting a pressure inside said vessel up to a predetermined increased temperature and a predetermined pressure respectively; and
d) injecting said byproducts into said dye solution thereby commencing a chemical reaction, said reaction proceeds during a predetermined time and further results in obtaining said organic material.

2. The organic material according to claim 1, wherein said vessel is associated with a second chemical reaction modulator in the form of at least one heating means.

3. The organic material according to claim 2, wherein said at least one heating means includes a number of electro-heating coils and/or a number of microwave heating devices.

4. The organic material according to claim 1, wherein said plasma housing is operatively associated with a DC power source capable of providing a 10 Kv voltage and a 150 mA current.

5. The organic material according to claim 1, wherein
said method further comprises:
providing an additional reactor sequentially assembled with said chemical reactor, wherein said chemical reactor supplies the material, produced therein, to said additional reactor;
and said additional reactor comprises at least one heating means.

6. The organic material according to claim 1, wherein said predetermined increased temperature ranges from 100 to 120.degree.C, and said predetermined pressure is substantially 1.5 atmosphere.

7. The organic material according to claim 1, wherein said dye solution ranges in the volume from 100 to 200 ml, and said predetermined reaction time ranges from 1 to 8 hours.

8. The organic material according to claim 1, wherein said plasma housing is substantially fed with a predetermined gas.

9. The organic material according to claim 8, wherein said predetermined gas is one of the following: air, oxygen, nitrogen, one of the noble gases, or a combination thereof.

10. The organic material according to claim 10, wherein
said vessel communicates with said plasma housing through an exit cup; and
the following conditions are provided:
said dye solution substantially consists of 1 mol of conjugated dye and 100 mol of water,
the plasma temperature inside said plasma housing is maintained substantially at 800.degree.C,
the temperature of said exit cup is maintained substantially at 20.degree.C,
the flow rate of said predetermined gas substantially ranges from 15 to 16 L/min,
and the contact time between the plasma and said solution ranges from 2 to 4 hours.

11. An organic material produced through a method comprising the steps of:
a) providing a chemical reactor, including a vessel made of predetermined material and associated with a first chemical reaction modulator in the form of at least one heating means;
b) dissolving a solid dye in water obtaining a dye solution that is placed in said vessel;
c) elevating a temperature and adjusting a pressure inside said vessel up to a predetermined increased temperature and a predetermined pressure respectively; and
d) heating said dye solution during a predetermined time, thereby commencing a chemical reaction, further resulting in obtaining said organic material.

12. The organic material according to claim 11, wherein said at least one heating means includes a number of electro-heating coils and/or a number of microwave heating devices.

13. The organic material according to claim 11, wherein said method further comprises:
providing an additional chemical reactor including a vessel of predetermined material, said additional reactor sequentially assembled with said chemical reactor; and
supplying the organic material, produced in said chemical reactor, to the vessel of said additional reactor.

14. The organic material according to claim 13, wherein
said additional reactor further comprises a plasma housing capable of initiating a plasma discharge, said discharge is capable of producing predetermined byproducts; and
said method additionally comprises the steps of:
placing a predetermined dye solution into the vessel of said additional reactor,
extracting said organic product in the dry form from said chemical reactor,
placing said organic product into said dye solution in the vessel of said additional reactor,
elevating a temperature and adjusting a pressure inside the vessel of said additional reactor up to a predetermined increased temperature and a predetermined pressure respectively; and
injecting said byproducts into said dye solution of the vessel of said additional reactor, thereby commencing a chemical reaction, said reaction proceeds during a predetermined time and further results in modifying properties of said organic material.

15. The organic material according to claim 13, wherein
said additional reactor further comprises a plasma housing capable of initiating a plasma discharge, said discharge is capable of producing predetermined byproducts; and
said method additionally comprises the steps of:
extracting said organic product in the dry form from said chemical reactor,
placing said organic product into the vessel of said additional reactor,
elevating a temperature and adjusting a pressure inside the vessel of said additional reactor up to a predetermined increased temperature and a predetermined pressure respectively; and
injecting said byproducts into the vessel of said additional reactor, thereby commencing a chemical reaction, said reaction proceeds during a predetermined time and further results in modifying properties of the surface of said organic material.

16. An organic material produced through a method comprising the steps of:
a) providing a chemical reactor, including a vessel made of predetermined material and associated with a first chemical reaction modulator in the form of at least one heating means, and with a second chemical reaction modulator in the form of a plasma housing capable of initiating a plasma discharge, said discharge is capable of producing predetermined byproducts;
b) providing an organic dye material in the dry form, said dye material is placed in said vessel;
c) elevating a temperature and adjusting a pressure inside said vessel up to a predetermined increased temperature and a predetermined pressure respectively; and
d) injecting said byproducts into said vessel containing said dye material thereby commencing a chemical reaction, proceeding during a predetermined time, and thereby obtaining said organic material.
